(19) United States
(12) Patent Application Publication
(10) Pub. No.: US 2015/0330209 A1
(43) Pub. Date: Nov. 19, 2015

(54) OPTIMAL TRAJECTORY CONTROL FOR DIRECTIONAL DRILLING

(71) Applicant: SCHLUMBERGER TECHNOLOGY CORPORATION, Sugar land, TX (US)

(72) Inventors: Neilkunal Panchal, Dhahran (SA); James Ferris Whidborne, Bedfordshire (UK); Martin Thomas Bayliss, Stonehouse (UK); Maurice Ringer, Roissy-en-France (UK)

(21) Appl. No.: 14/652,164

(22) PCT Filed: Dec. 13, 2013
(86) PCT No.: PCT/IB2013/060922

§ 371 Date: Jun. 15, 2015

Related U.S. Application Data
(60) Provisional application No. 61/737,015, filed on Dec. 13, 2012.

(51) Int. Cl. E21B 47/022; G05B 13/04; E21B 7/06

(52) U.S. Cl. CPC E21B 47/022; E21B 7/06; G05B 13/042

(57) ABSTRACT

A feedback control system for steering a tool along a well-plan. Optimum steering instructions may be generated by a recursive optimization of multiple objectives. These objectives can include accuracy and quality. The quality objective can include the objective of drilling a smooth borehole by minimizing strain energy and torsion. The accuracy objective can include the objective of minimizing the deviation of the borehole trajectory during the real-time drilling process from a predefined well-plan. The trajectory control problem, therefore, can be a multi-objective problem where, in some embodiments, the weightings of the individual objectives can be adjusted along the process.

### BACKGROUND

Consumption of oil and gas serves more than half of the world's energy demand. Since the 1980s the rate of production of existing oil fields is increasingly greater than the rate of discovery of new reserves. To meet future energy demands, it will be necessary to drill for oil in more challenging oil reserves in more hostile environments. Rotary drilling systems are used to create boreholes to produce oil and gas from deep beneath the Earth's surface. Boreholes that are tailored to maximize contact with oil/gas reservoirs increase the volume of production recovery.

Directional drilling is the process of creating boreholes by steering a drilling tool along a well-plan defined by a multidisciplinary team of: reservoir engineers; drilling engineers; geo-steerers; and geologists amongst others. Since their inception, rotary steerable systems (RSS), have enabled steering automation, with down-hole sensors, actuators, and processors close to the bit. This enables the drilling of longer reaching wells, and complex well geometries. Automation thus adds capability to the drilling process and is a value driver with the potential to reduce cost per foot of a well, and maximize production which can be recovered in a reservoir. Since oil and gas is a finite resource, reducing the cost per barrel is required to economically meet energy demand for the near future.

### BRIEF SUMMARY

Embodiments of the invention include a feedback control system for steering a tool along a well-plan. In some embodiments optimum steering instructions are generated by a recursive optimization of multiple objectives. These objectives can include accuracy and quality. The quality objective can include the objective of drilling a smooth borehole by minimizing strain energy and torsion. The accuracy objective can include the objective of minimizing the deviation of the borehole trajectory during the real-time drilling process from a predefined well-plan. The trajectory control problem, therefore, can be a multi-objective problem where, in some embodiments, the weightings of the individual objectives can be adjusted along the process.

In some embodiments of the present application, a method for determining an optimal borehole trajectory in real-time for drilling a borehole in a drilling procedure using a drilling system through an earth formation is provided, the method comprising: receiving a well-plan, where the well-plan is designed to describe a borehole that extends from a surface location to a goal in the earth formation (the goal comprising a volume of hydrocarbons or a hydrocarbon reservoir), receiving data in real-time from the operation of the drilling system, including the drill bit, borehole data and determining a borehole trajectory for directing the drilling system to drill the borehole based on the well plan, the drill bit and/or borehole data, wherein the borehole trajectory is determined using a plurality of objectives comprising at least a first objective of minimizing at least one of strain energy and torsion and a second objective of minimizing deviation of the borehole trajectory from the well-plan.

Other objectives may be included in the plurality of objectives and the objectives may be optimized using recursive optimization. In some aspects, the objectives may iteratively optimized during the drilling procedure.

In embodiments of the present invention, strain energy, torsion and/or frictional effects may set as objectives. The strain energy, torsion and/or frictional effects may be calculated with respect to drill pipe and/or the drill bit used in the drilling system, to a casing string (casing pipe) that may be used to case the borehole after it is drilled or may be calculated as inherent effects of the borehole, For example, prior drilling and/or casing data may be used to determine the strain energy, torsion and/or frictional effects on the drilling system and/or the casing string. In some aspect, strain energy, torsional effects and/or frictional effects may be determined so as to provide for reducing wear on the drilling system and providing for efficient casing of the wellbore prior to production of hydrocarbons from the wellbore. Casing comprises deploying a casing string in the wellbore.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 shows a block diagram of a trajectory work flow.

FIG. 2 shows a concept of a Model Predictive Control according to some embodiments of the invention.

FIG. 3 shows a graphical representation of the Model Predictive Control concept.

FIG. 4 shows a graph of the path produced from different curvature constraints.

FIG. 5 shows a graph of the path produced from different βₐₜₜ values.

FIG. 6 shows an example of a well plan.

FIG. 7 shows a visualization of the well-plan, drilled trajectory, and correction path.

FIG. 8 shows the deviation from the well-plan along the trajectory in simulation time.

FIG. 9 shows the toolface signals for the various curvature constraints.

FIG. 10 shows the attitude of the drilling tool verses measured depth along the borehole trajectory.

FIG. 11 shows the curvature of the correction path at the location coincident with the drill-bit as calculated in the finite horizon optimization along the measured depth of the borehole trajectory.

FIGS. 12 and 13 show the effect of the constraints on curvature.

FIG. 14 shows the deviation of the borehole trajectory from the well-plan.

FIG. 15 shows the attitudes in terms of inclination and azimuth angles.

FIG. 16 shows the curvature of the drilled trajectory as measured by simulation.

FIG. 17 shows minimum strain energy curves.

FIG. 18 shows an example of a computational system that can be used to perform some embodiments of the invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Embodiments of the invention include a feedback control system for steering a tool along a well-plan. In some embodiments optimum steering instructions are generated by a recursive optimization of multiple objectives. These objectives can include accuracy and quality. The quality objective can include the objective of drilling a smooth borehole by minimizing strain energy and torsion. The accuracy objective can include the objective of minimizing the deviation of the borehole trajectory during the real-time drilling process from a predefined well-plan. The trajectory control problem, therefore, can be a multi-objective problem where, in some embodiments, the weightings of the individual objectives can be adjusted along the process.

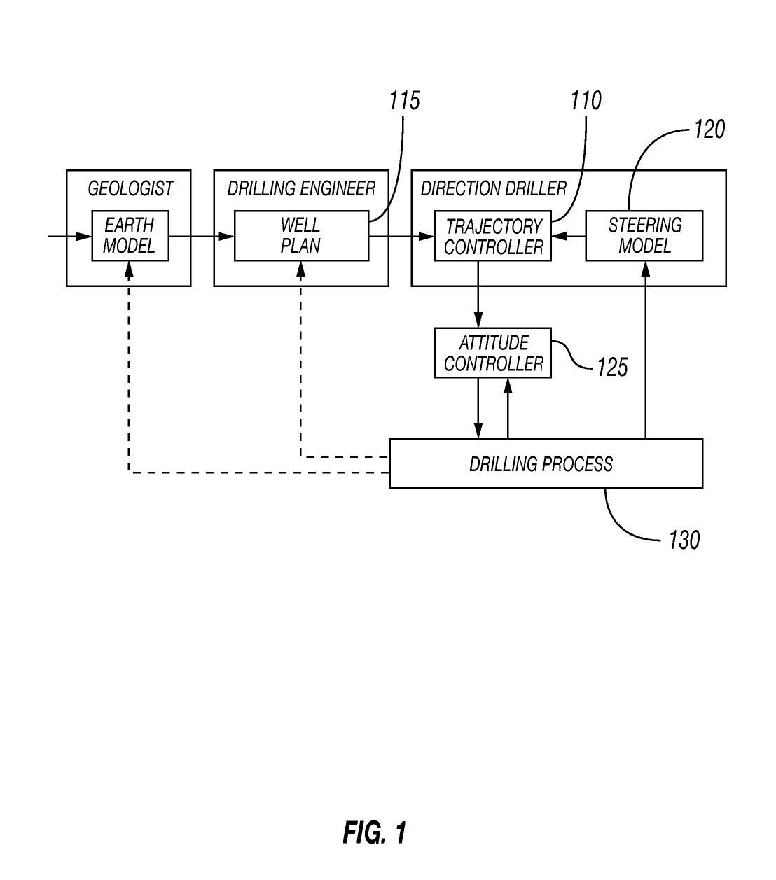

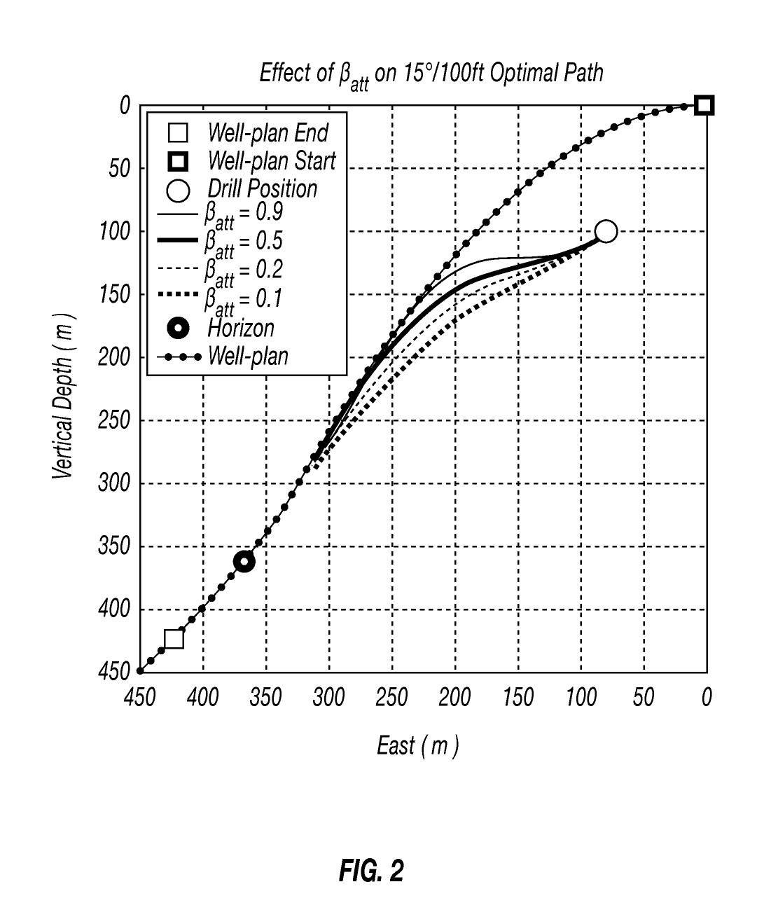

FIG. 1 shows a block diagram of a trajectory control workflow. Trajectory controller 110 receives a well plan from drilling engineer 115 and feedback data from the well from steering model 120. Using the well plan and the feedback data, trajectory controller 110 can provide steering commands to attitude controller 125, which controls drilling process 130.

The accuracy of the placement of the well-bore trajectory along a well-plan can be important for economic reasons. To this end, in some embodiments, the well-plan can be designed to maximize hydrocarbon recovery. The accuracy can be important for safety reasons since the well-plan may be designed to avoid geopressure regions, and existing wells in the reservoir. The consistency of drilling a wellbore as close as possible to a well-plan can be important for cost reduction as large deviations from a well-plan frequently require the drilling of sidetrack wells to correct for these inaccuracies. Non-productive drilling time can be costly in a drilling operation and may contribute wasted time in an otherwise costly process. The quality of the well-bore in terms of its smoothness can be important since, after drilling, casing would need to be run down-hole. Furthermore A producing well may have additional down-hole equipment such as pumps. Hence a smooth minimum energy path may minimize risks associated with the bending of pipe and equipment run downhole.

In some embodiments trajectory controller 110 can send steering commands to attitude controller 125 in a closed loop based on a well-plan and/or other objectives. In some embodiments trajectory controller 110 can optimize steering instructions based on a steering model. The resultant steering commands can be communicated to a downhole system.

Directional drilling can be defined as the navigation of a borehole trajectory along a predefined well-plan with respect to a geological model. Some embodiments of the invention can interface an attitude control system with a well-plan by generating commands for the down-hole attitude control system in order to follow a well-plan.

In some embodiments a controller can dynamically generate an optimal trajectory coincident with the real-time measured pose of a drilling tool in order to guide the drilling tool along the well-plan. This optimal trajectory can be represented using B-splines.

In some embodiments the optimal path can be a continuous curve and/or for a cubic b-spline the first and second derivatives may exist; hence the tangent and normal vectors at a given location along the path can be extracted. From the tangent and normal, expressions for the tool-face, curvature and the attitude can be calculated. This attitude set-point command can be communicated to the BHA in order to steer the borehole. In another embodiment, the toolface and curvature can also be communicated in the absence of an attitude control system.

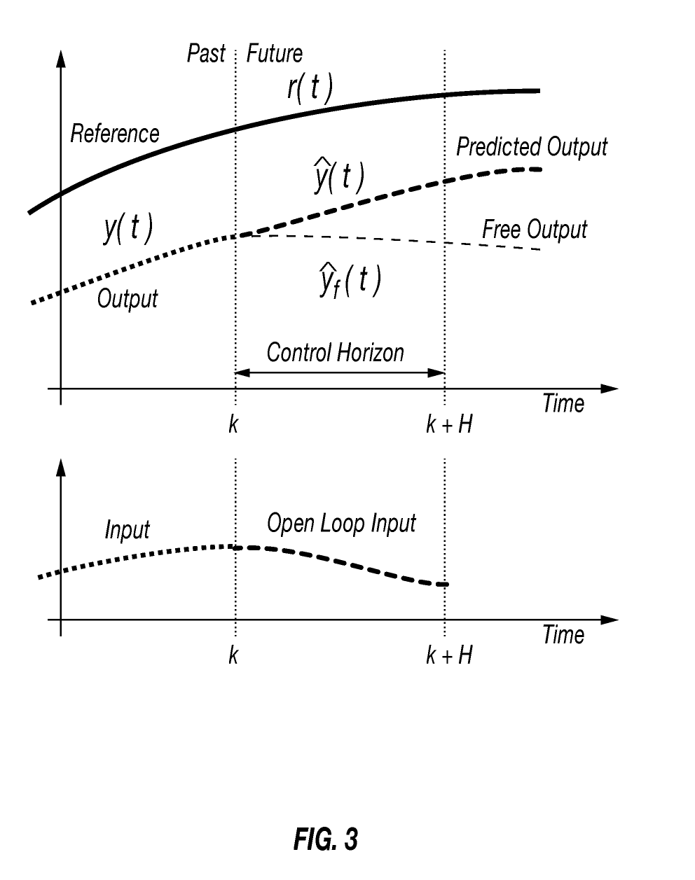

In some embodiments, a Model Predictive Controller can be used is designed. The concept of Model Predictive Control (MPC) is shown in FIG. 3. An MPC controller involves solving an optimization problem to minimize some objective function over a finite future horizon k+H, given measurements at time k in order to determine the optimal future output and control actions over that horizon. The optimization considers a model of the system dynamics along with state and input constraints. The optimum open-loop control inputs should in the absence of disturbances drive the system along the predicted output, y. In an MPC controller the initial input can be applied for the duration until the next measurement sample is received. The horizon can be shifted and the process is iterated generating a closed loop control system.

The finite horizon optimization will be formed as a convex optimization problem with the following constraints.

Minimize ƒ₀(y) i=1, . . . ,m (3.1)

subject to ƒᵢ≦0 i=1, . . . ,m (3.2)

hⱼ(y)=0 (3.3)

The objective function ƒ₀ can consist of two terms to be minimized. The first is a minimum energy term to generate a smooth path. The second term will be to minimize the deviation from the well-plan. The equality constraints represent the measured pose of the system. The inequality constraint represents the plant dynamics.

In this section, the representation of the modeling of the steering behavior of the drilling tool for the convex optimization problem is detailed. The position of the drilling tool at time t is represented by y(t), and the attitude x(t) is represented as a unit vector such that

\dot{y}(t)=νᵣₒₚx(t), (4.4)

where νᵣₒₚ is the rate of penetration of the drilling tool. The attitude x(t) can be modeled as

\dot{x}=ω×x, (4.5)

where ω represents an axis in which the attitude x rotates about and the magnitude ∥ω∥ represents the curvature of the drilling tool. In some embodiments a variable build rate controller can be used where the closed loop dynamics are

\dot{x}=k(x_{d}−(x_{d}·x)x), (4.6)

It can be assumed that the inner loop attitude control system is stable and given an attitude demand x_{d} signal, that the drilling tool will reach this attitude in minimum time and hold this attitude.

Between measurement samples the average curvature k of the hole drilled will vary between zero and the maximum curvature capability by the fraction of time in which the attitude is reaching holds the demand attitude x_{d}.

It is a reasonable assumption to make that the length scale of the well-plan, is much greater than the length scale of the hole drilled between measurement samples. Hence an approximation to the dynamics of the overall closed loop system is expressed as

\dot{y}(t)=νᵣₒₚx_{d}(t) (4.7)

This implies a future sequence control inputs x_{d}(t) can be recovered from the first derivative of the output y. Given a curve ŷ(λ) represented as a spline the attitude demand signal can simply be found by

$${x}_{d} ( λ ) = \frac{\frac{d \hat{y}}{d λ} ( λ )}{‖ \frac{d \hat{y}}{d λ} ( λ ) ‖} . \qquad ( 4.8 )$$

When represented as a spline, this value is

$${x}_{d} ( λ ) = \frac{{N}^{′} ( λ ) p}{‖ {p}^{T} {N}^{′ T} ( λ ) {N}^{′} ( λ ) p ‖} \qquad ( 4.9 )$$

In some embodiments, it can be assumed for the purpose of the trajectory control design that a curve ŷ(λ), represented as a b-spline, may be feasible to track for an attitude control system. In some embodiments an open-loop sequence of control inputs x_{d} can be generated provided that the curvature everywhere along ŷ(λ) is less than the maximum tool curvature ∥ω∥. The model of the drilling tool for the subsequent optimization can be represented as an inequality constraint on the curvature

∥\dot{x}(t)∥∥≦∥ω∥. (4.10)

This inequality constraint will be enforced point-wise along each segment of a b-spline representation of the predicted output trajectory ŷ

p^{T}Nⁿ(λ)^{T}Nⁿ(λ)p≦R (4.11)

Since the integrand of 4.10 is a Gram-Matrix, it is positive definite, and hence this forms a convex quadratic constraint.

By way of example, an offline well-plan, r(λ), with respect to geological targets and BHA design may be used:

r(λ)=N(λ)q, (4.12)

where N(λ) are b-spline basis functions of degree d with respect to a parameter λε[d−1, mᵣ+d−1] along the plan with mᵣ segments, and q represent the control points. The accuracy aim is to minimize the deviation

∫ₜ_{₀}^{t}^{_{f}}∥y(t)−r(λ*(y(t)))∥₂dt (4.13)

of the borehole trajectory y(t) from the well-plan r(λ*(y(t)) from some initial time t₀ to some final time t_{f}. In some embodiments, the time taken to follow the plan is of less importance and/or the control of ROP is in an exosystem and not in the scope of this control system. Hence the reference r(λ*(y(t)) may not be time dependent and instead dependent on the current position of the drilling tool y(t). The parameter λ*(y(t)) can be defined to be

$${λ}^{*} ( y ( t ) ) = {arg min}_{λ} {‖ y ( t ) - r ( λ ) ‖}_{2} , \qquad ( 4.14 )$$

and can represent the closest point on the well-plan to the drilling tool. Furthermore the final time t_{f} is free and represents the end of the well-plan.

The structure of the center-line attractor is taken from to be a term in the objective function to minimize the term

E_{d}=∫_{λ}_{₀}^{λ}^{₁}∥x(λ)−c(λ)∥²dλ, (4.15)

where x(λ) is the correction path to be solved for, and c(λ) is the well-plan. In some embodiments it can be assumed that the well-plan c(λ)=N(λ)q is given in terms of its control points q.

E_{d}=p^{T}Ap−2p^{T}Aq+q^{T}Aq (4.16)

In embodiments of the present invention, the number of control points of q will be chosen and will define the length of the horizon ahead of the drilling tool. In embodiments of the present invention, anly a small section of the well-plan may be taken as an input for the curve attractor from the well-plan r. From the closest point found on the well-plan, the corresponding control points at the beginning of the support for this section define the first control point for q and the horizon length determines the end.

The matrix A=aᵢⱼ can be found from evaluating the integral

∫Nᵢ^{d}(λ)Nⱼ^{d}(λ)dλ. (4.17)

In some embodiments, due to the local support property of the splines for the cubic case, the basis Nᵢ³(t) for a given t is non-zero for 4 segments, i. So A, can be found by constructing a square zero matrix depending on the number of control points required by q, and then copying the matrix A

$$\hat{A} = [ \begin{matrix}\frac{1}{252} & \frac{43}{1680} & \frac{1}{72} & \frac{1}{5040} \\ \frac{43}{1050} & \frac{33}{140} & \frac{149}{720} & \frac{1}{84} \\ \frac{1}{72} & \frac{149}{720} & \frac{49}{180} & \frac{19}{720} \\ \frac{1}{5040} & \frac{1}{84} & \frac{19}{720} & \frac{1}{252}\end{matrix} ] \qquad ( 4.18 )$$

along the diagonal starting from (1,1).

Given the measured position y, the measured attitude x of the tool, a section of the wellplan c corresponding to the closest point and a fixed horizon ahead, and knowledge of the curvature capability of the tool κ̅, the optimization problem (4.19) can generate control points p to be the optimal path coincident with the position and attitude of the tool to guide the tool back to the well-plan.

$$\begin{matrix}{minimize}_{p} & ( 1 - {β}_{{w}_{att}} ) {p}^{T} Qp + {β}_{att} ( {p}^{T} Ap - 2 {p}^{T} Aq + {q}^{T} Aq ) + {β}_{2} ( {y}_{1} ) \\ subject to & N ( d - 1 ) p = y ( t ) \\ & {N}^{′} ( d - 1 ) p = x ( t ) {y}_{1} \\ & {y}_{1} > 0 \\ & {p}^{T} {{N}^{″} ( \frac{i}{d} )}^{T} {N}^{″} ( \frac{i}{d} ) p \leq \overline{κ} \\ & i = 2 d , … , md .\end{matrix} \qquad ( 4.19 )$$

In embodiments of the present invention, the terms in the objective function to be minimized are the energy and curve attractor terms. The coefficient 0≦βₐₜₜ≦1 determines the trade-off between following objectives, the well-plan and drilling a smooth hole.

From the optimal control points p, the optimal state trajectory ŷ(λ) can be found by

\hat{y}(λ)=N(λ)p (4.20)

The curvature constraint used in equation (4.19) is an approximation to the curvature. In order to generate a feasible path which will not violate the true curvature capability of the drilling tool, the value for k is modified after the curvature κ(ŷ) is calculated for the path ŷ.

In some embodiments the method can include: solving the unconstrained curvature case; comparing the maximum curvature resultant curve max_{λ}κ (\hat{λ})) to the curvature capability of the drilling tool ∥ω∥. If the curvature constraint is violated then the following algorithm can be used to determine the optimum path ŷ. This algorithm may be a bisection search.

In some embodiments the optimization (4.19) can be constrained for absolute curvature using the following algorithm (Algorithm 1).

```
  1: Set κ̅ₜₒₚ and κ̅_{bottom} = 0 and κ̅ = κ̅/2
  2: Solve Optimization (4.19)
  3: Find State Trajectory ŷ from (4.20)
  4: κₘₐₓ = max_{λ} κŷ(λ)
  5: if ||κₘₐₓ − ||ω|||| ≦ γ then
  6:  return ŷ
  7: else
  8:  if κₘₐₓ < ||ω|| Or Infeasible then
  9:   κ̅ = ½( κ̅ₜₒₚ + κ̅)
10:  κ_{bottom} = κ̅ goto 2
11:  else
12:   κ̅ = ½( κ̅ₜₒₚ + κ̅)
13:  κₜₒₚ = κ̅ goto 2
14:  end if
15: end if=0
```

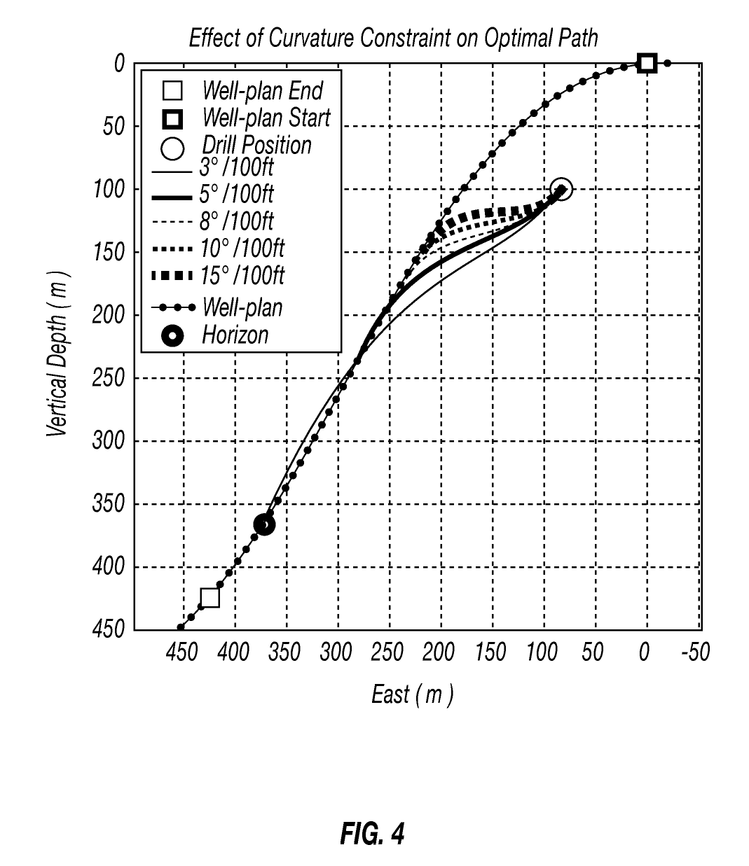

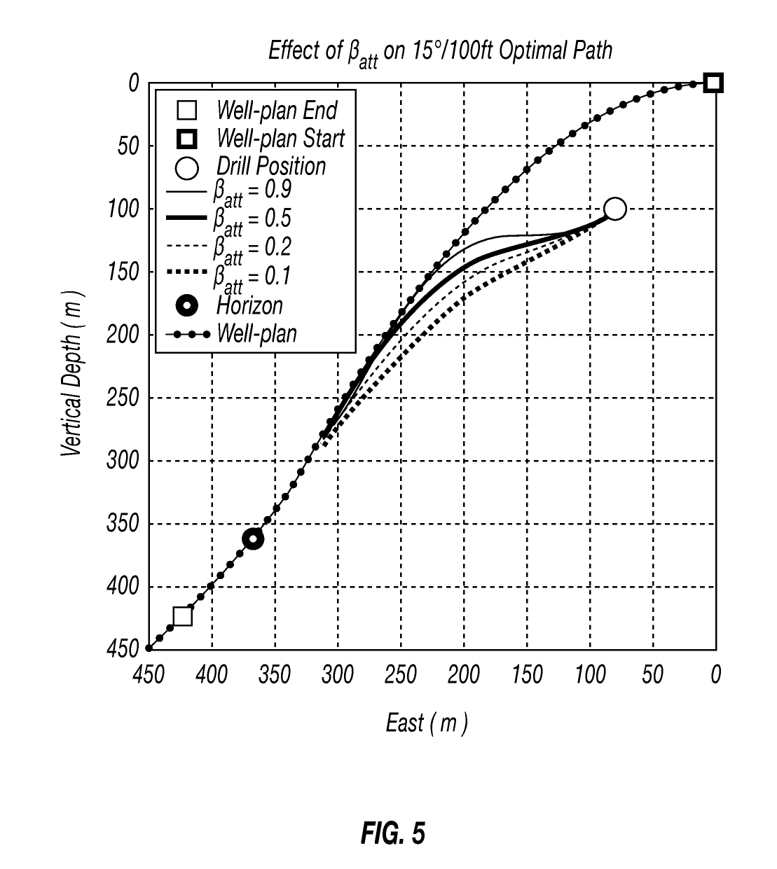

A feature of the optimization as provided in (4.19) are the weights βₐₜₜ in the objective function. These weights represents a tradeoff between following the well-plan and drilling a smooth borehole. A user/processor interacting with the trajectory controller can vary these parameters in real time during the drilling process. The effects of these weights are shown in FIG. 4. Moreover a curvature constraint can be imposed to be less than the curvature capability of the tool. The effect of this is shown in FIG. 5.

FIG. 4 displays the path ŷ produced as a result of the finite horizon optimization problem. A well plan is displayed in red. Here a cubic spline d=3 with m=30 segments is solved for starting pose with position r(λ=d)=[0, 0, 0] and attitude r′(λ=d)=[0, 0, 1] represented by the blue square, and ending at the pose with position

$$r ( λ = m - 1 ) = [ \frac{600}{\sqrt{2}} , 0 , \frac{600}{\sqrt{2}} ]$$

and attitude

$${r}^{′} ( λ = d ) = [ \frac{1}{\sqrt{2}} , 0 , \frac{1}{\sqrt{2}} ]$$

represented by the red square. The weights of the objective function are chosen to be α₁=0.8, and α₂=0.1, which is biased towards being shorter. The curvature constraint is taken to be 7°/100 ft.

From a starting pose with position ŷ(λ=d−1)=[100, 0, 80] attitude

$${\hat{y}}^{′} ( λ = d - 1 ) = [ \frac{1}{\sqrt{2}} , 0 , \frac{1}{\sqrt{2}} ] ,$$

predicted well-plans are generated with a horizon of m=15 segments from the finite horizon optimization. The weights of the objective function can be chosen to be α₁=0.8, and α₂=0.1. The curvature constraints can be taken to be ∥ω∥ε{3, 5, 8, 10, 15}°/100 ft. The trade-off weight can be taken to be βₐₜₜ=0.9. The results from FIG. 4 demonstrate the generation of feasible smooth paths which are coincident with the pose of the drilling tool in order to track back to the well-plan. It can be seen that tightening the curvature constraint from 15°/100 ft down to 3°/100 ft has the effect of generating a path which meets the well-plan much further away from the drilling tool with less curvature. It can be seen that much of the path is coincident with the well-plan towards the end of the horizon. For the case of the 3°/100 ft path, there is an overshoot and the path is unable to be coincident with the well-plan due to its curvature constraint.

FIG. 5 shows the results of the finite horizon optimization investigating the effect of changing the trade-off weight βₐₜₜ on the correction path. Like FIG. 4, the starting pose is with position ŷ(λ=d−1)=[100, 0, 80] and attitude

$${\hat{y}}^{′} ( λ = d - 1 ) = [ \frac{1}{\sqrt{2}} , 0 , \frac{1}{\sqrt{2}} ] .$$

Correction paths can be generated with a horizon of m=15 segments from the finite horizon optimization. The weights of the objective function can be chosen to be α₁=0.5, and α₂=0.5.

Here the same well-plan r as FIG. 4 is taken as the reference, and the start of the correction path representing the pose of the drilling tool is represented as a green circle. The trade-off weight βₐₜₜ is varied from βε{0.1, 0.2, 0.5, 0.9}. It can be seen that when reducing βₐₜₜ, the optimal correction path favors drilling a smoother straighter path. In addition changing this parameter influences how aggressively to track the well-plan and how soon to return to it.

In some embodiments these weights and constraints can be tuned offline, where the values can be scheduled to vary along the drilling process. That is to say, for example, for sections of the well where speed and smoothness are more important, then the value of βₐₜₜ can be set low. In situations, for example, for sections of a well-plan in the oil-reservoir where the plan is designed to maximize hydrocarbon recovery, the accuracy would be more important than the speed for economic reasons regarding the subsequent hydrocarbon recovery. Furthermore In a real-time drilling operation, the ability to change these weights and curvature constraints can prove to be valuable where driller experience would interact with this system as a human in the loop.

Given the finite horizon optimization, the MPC trajectory controller is described in this section. The procedure is summarized in Algorithm 2.

A well-plan r can be designed by a driller and/or a well plan method or system. A horizon length in terms of the number of segments of a b-spline can be chosen. This can be chosen to be sufficiently large such that the corresponding distance is larger than the distance which can be drilled between samples. A measurement can be taken of the drilling states x(t), y(t). From this the closest point to the well-plan is chosen and a corresponding section of the well-plan, where the number of segments matches the horizon length is taken. If required, the values of the trade-off weight β can be changed along with ∥ω∥. Now the finite horizon optimization problem is solved in order to determine the optimal control points. From these control points, the optimal state trajectory ŷ(λ) can be determined from which the closed loop control x_{d} is communicated to the attitude control system. The algorithm can then be recursed until the end of the well-plan is reached. Algorithm 2 can include the following.
1: Set horizon length
2: Measure position y and attitude x
3: find c
4: Set β, ∥ω∥
5: Solve ŷ from Algorithm 1
6: Determine feedback value x_{d} from equation (4.9) and apply this to the attitude control system for the next sample period
7: Goto 2=0

### Simulation Results

In this section, an example of an MPC trajectory controller is tested in a time domain simulation. The model of the drilling process is taken from a commercial drilling simulator ST 2, which models the drill-string and the hole propagation process through finite element analysis. Two sets of simulations are produced to follow the same well-plan from the same pose. The first will demonstrate the effect of curvature constraints on the correction path to the tracking performance. The latter will consider the tracking performance against the variation in the weighting term βₐₜₜ. This section begins by describing the well-plan used in the simulations.

In this simulated example, the correction path is chosen to be a cubic b-spline curve with m=12 segments. The simulation will drill along a total depth of 190 m. The minimum energy weights are chosen to be α₁=0.1, and α₂=0.5. The ST 2 model parameters are chosen to be a push the bit drilling tool, drilling with an initial inclination of 85°. At an initial position of [145, 500, 145]. The attitude set-point is taken corresponding to a value of A=0.4 ahead of the bit. A new attitude demand signal x_{d} is downlinked every 5 m, and the drilling tool is penetrating at a rate of ROP=30 m/hr. The sensors are located at a distance of 1 m behind the bit.

A well-plan is generated with the starting pose is with position r(λ=d)=[150, 0, 500] and attitude r′(λ=d)=[0, 0, 1] being due east. A cubic d=3 b-spline with m=60 segments is constructed to a final pose with position r(λ=m−1)=[160, 15, 720] and attitude

$${r}^{′} ( λ = m - 1 ) = \frac{1}{5 \sqrt{2}} [ 1 , 2 , 7 ] .$$

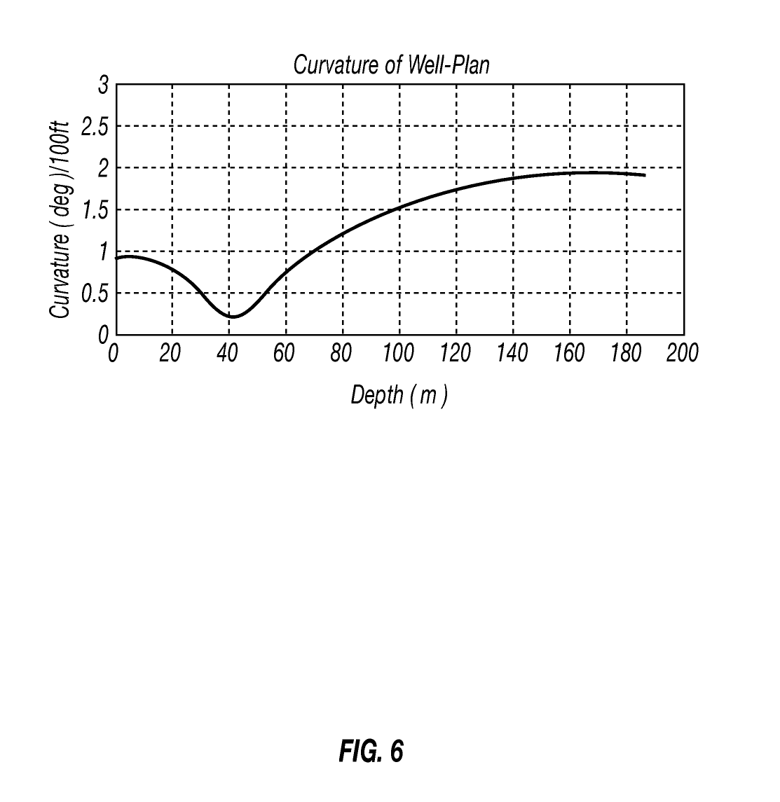

The energy weights of the optimization are chosen to be α1=0.8, and α2=0.1. The path is planned with a curvature constraint of 2°/100 ft, and the curvature profile along the depth of the well-plan as shown in FIG. 6.

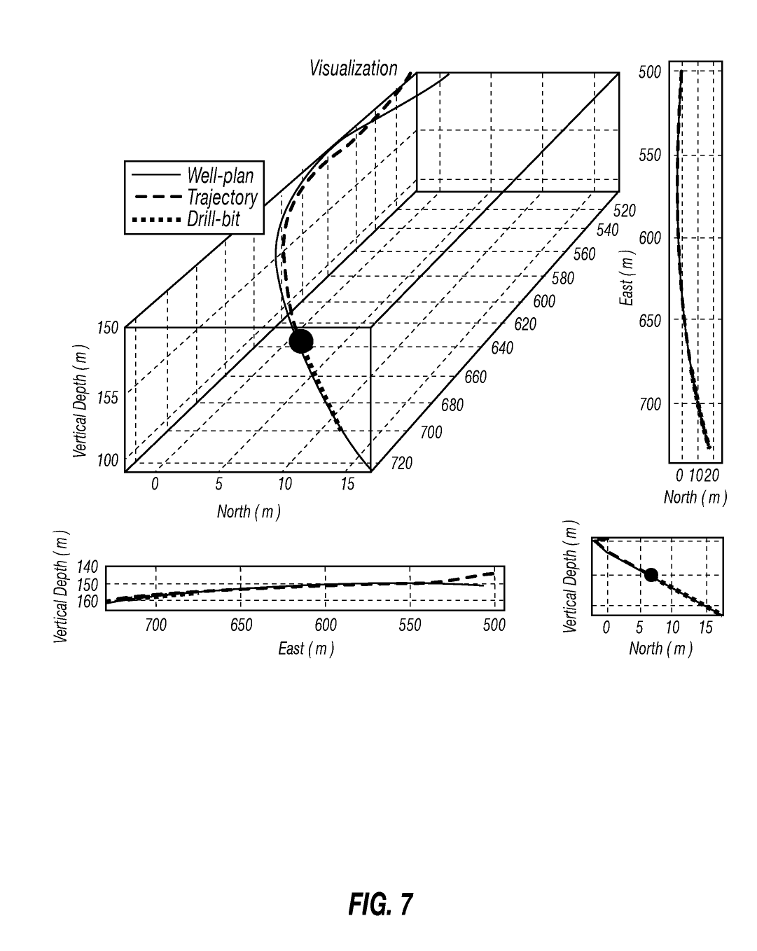

The MPC trajectory controller can run for four cases where the dogleg of the correction path is varied. The cases run are for ∥ω∥ε{3, 5, 7, 9}°/100 ft. A visualization of the well-plan, drilled trajectory, and correction path can be seen for the case of 9°/100 ft in FIG. 7.

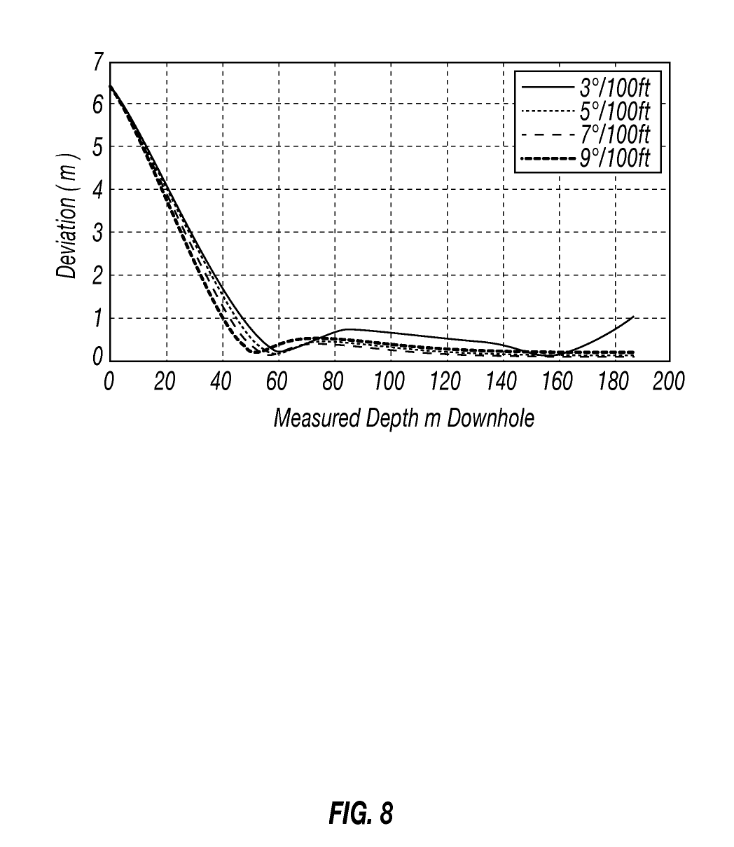

The deviation from the well-plan along the trajectory in simulation time measured from the bit to the closest point in the well-plan is shown for all the cases in FIG. 8. It can be seen that the trajectory which meets the well-plan at the lowest measured depth is the case where the correction path is constrained to be 9°/100 ft. The decreasing of the curvature constraint has the effect of reaching the well-plan to meet at a further measured depth. In addition is can be seen that the deviation from the well-plan is less than 1 m for all but the cases of the 3°/100 ft, and for these three cases the tracking is less than 0.5 m after the first 60 m drilled. For the 3°/100 ft case, after 160 m the deviation begins to diverge. This can be explained due to the fact that the well-plan at this stage is at a curvature of 2°/100 ft, and the control effort is significantly compromised at a relatively high curvature.

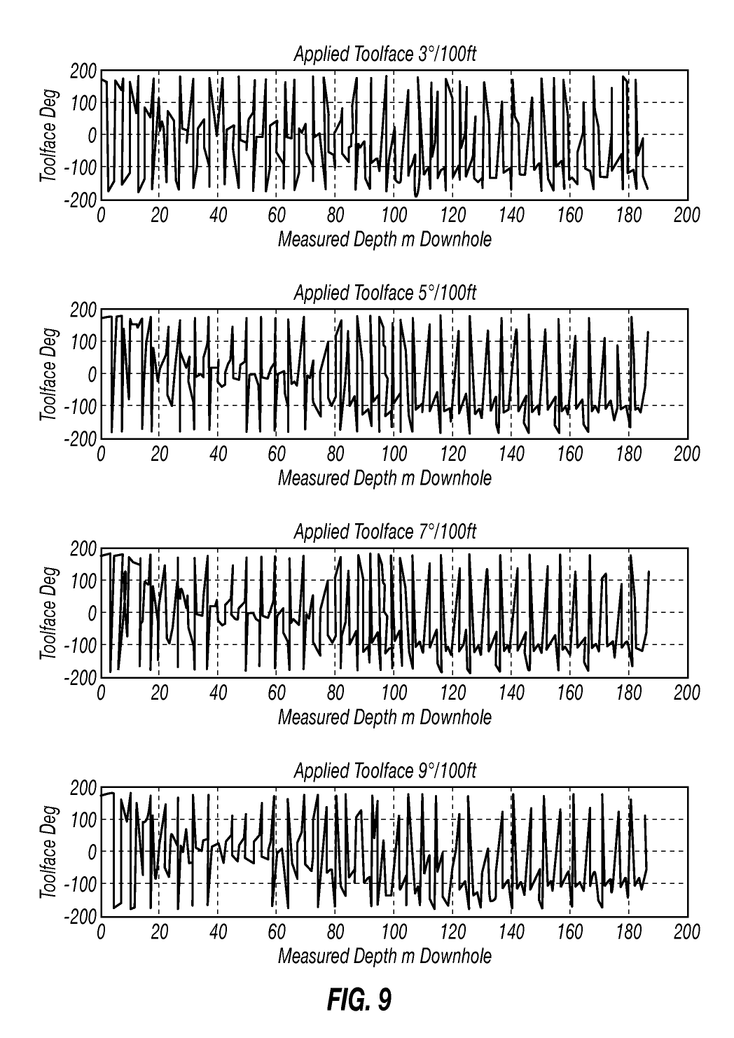

FIG. 9 shows the toolface signals for the various curvature constraints. These toolface signals are generated by an attitude control system. The comparison of the constraints is more present in the measured depth range of 40-60 m. This corresponds to the depth along the trajectory at which the drilling tool converges with the well-plan from FIG. 8. In the case of 3°/100 ft curvature constraint, the toolface is held in much shorter bursts than in the 9°/100 ft case in the 40-60 m range in FIG. 9. This is because to achieve a lower net curvature, the toolface must cycle a full revolution between the bursts of holding toolface in order to achieve steering at a lower toolface. The length of the bursts of holding toolface increased as the curvature constraint increases. It can also be seen that this cycling of the toolface can be seen along the rest of the well and is due to the fact that the well-plan is of a lower curvature to the constraints.

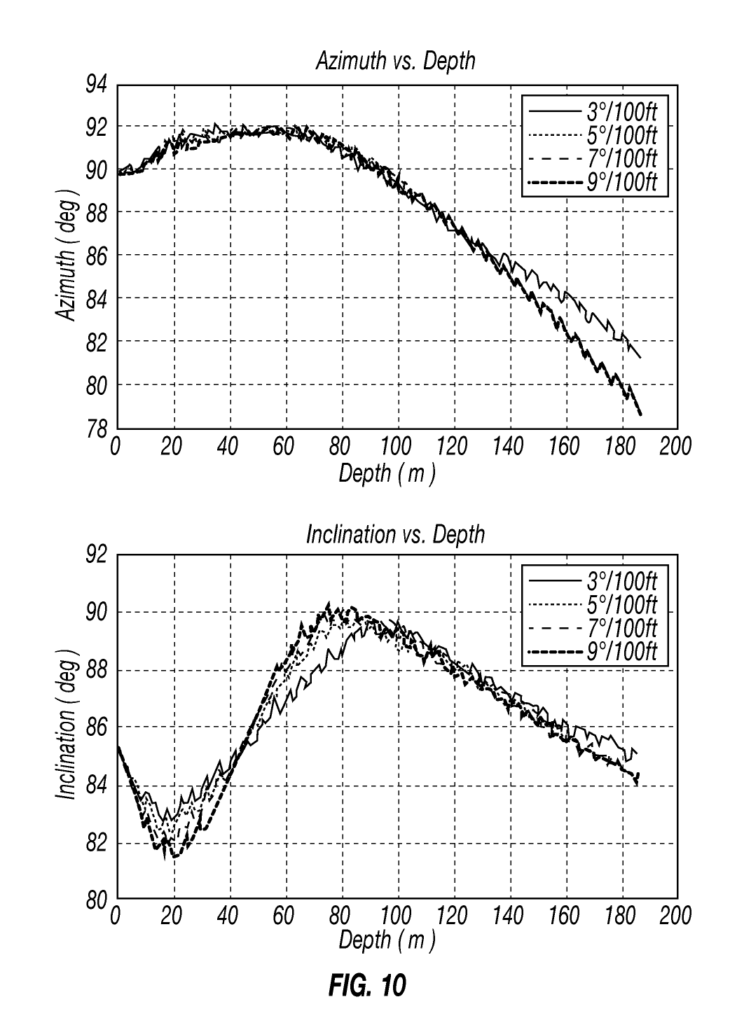

FIG. 10 shows the attitude of the drilling tool verses measured depth along the borehole trajectory. It can be seen that the variation in attitude fluctuates about every 5 m by 0.5° in inclination and in azimuth. This corresponds to the depth drilled between when a new attitude set point is communicated, where within this time the drilling tool reaches and holds an attitude by varying its toolface angle. The effect of the curvature constraints are clearly evident in the inclination, where the gradient represents the constraints. It can be seen that for the 3°/100 ft curvature constraint after 140 m there is a clear difference in performance in the tracking.

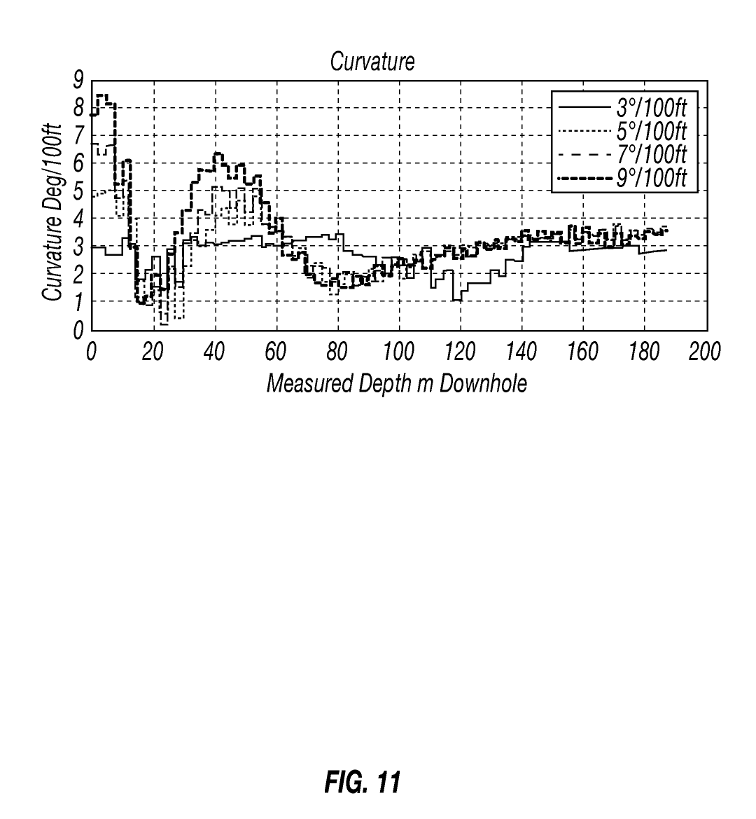

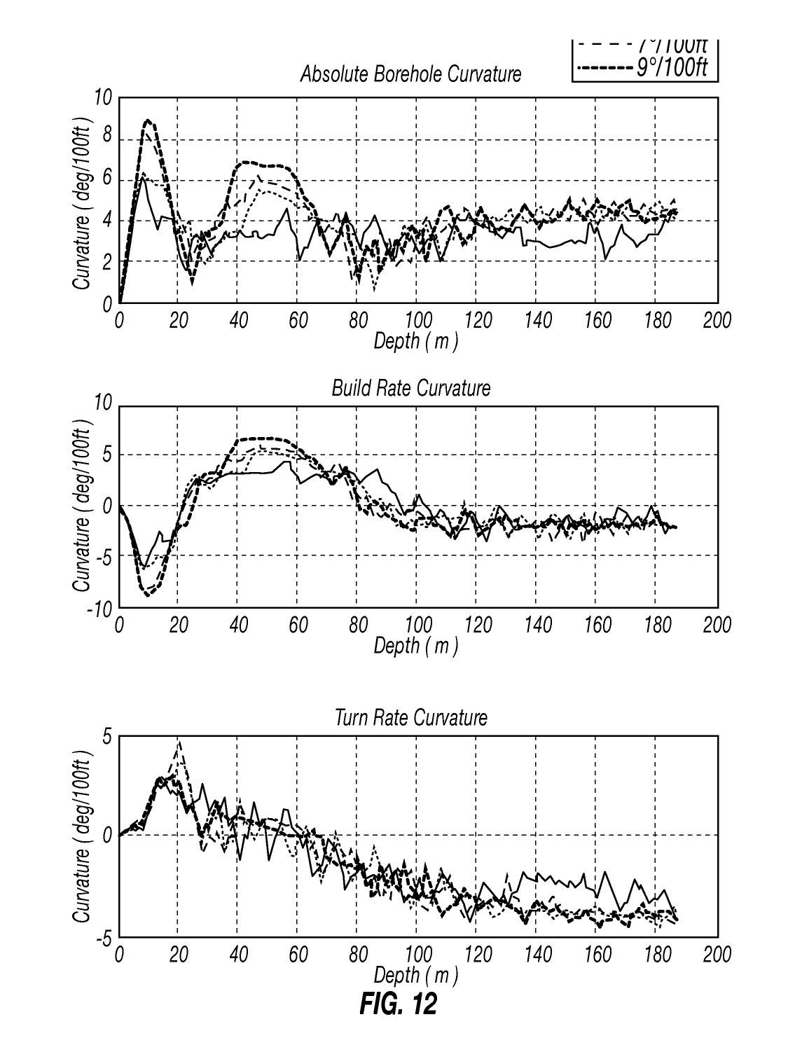

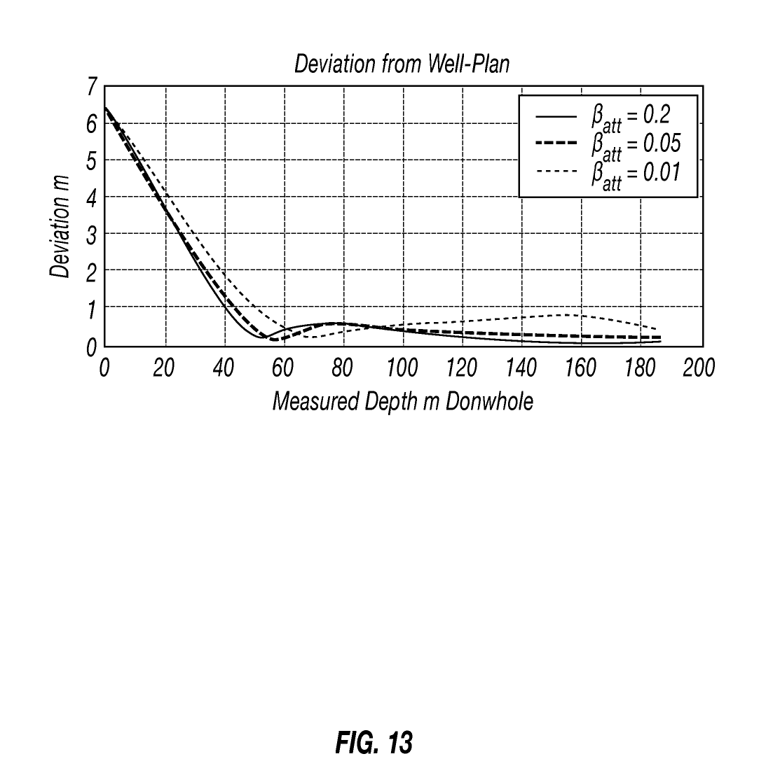

The curvature of the correction path at the location coincident with the drill-bit as calculated in the finite horizon optimization is shown along the measured depth of the borehole trajectory in FIG. 11. Since the correction path is only calculated as an outer-loop to the attitude control system it is shown in discrete values. The effect of the curvature constraint is shown to restrict the correction-path curvature in the early stages where the drilling tool steers aggressively to reach the well-plan. The constraint for the 3°/100 ft case is active for much of the trajectory for the initial section of the correction-path.

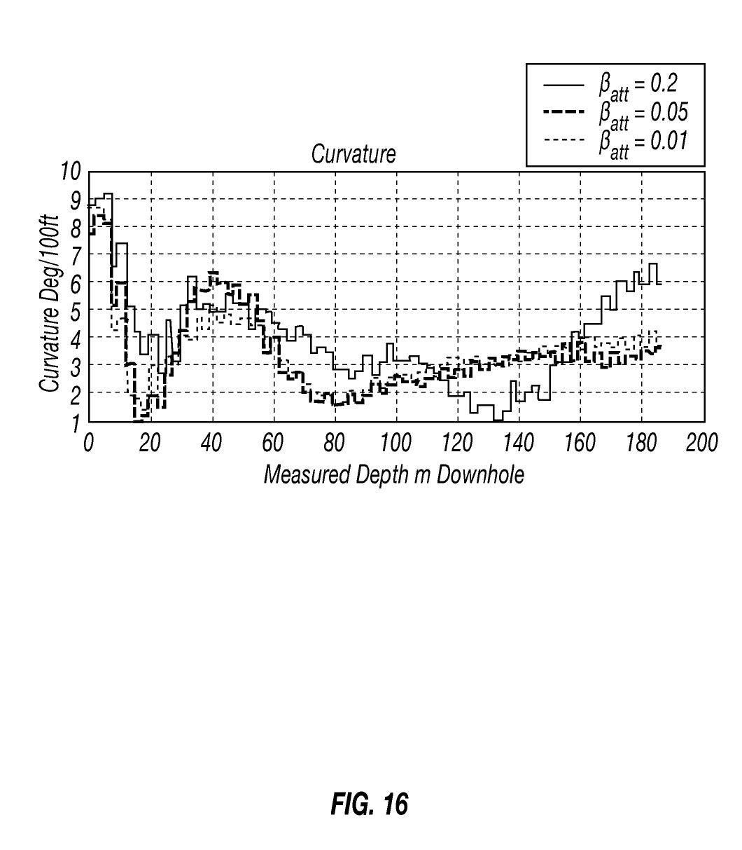

The curvature of the drilled trajectory as measured by ST 2 is shown in FIG. 16 for the absolute curvature, and the build-rate and turn-rate. There is a clear difference between the absolute borehole curvature and the predicted borehole curvature from FIG. 11. This is due to transient effects in the response of curvature, and also due to unmodelled dynamics. Nevertheless There is a similarity in the shape of the absolute borehole curvature plots and the instantaneous predicted correction path curvatures. Furthermore the curvature constraint limits the curvature of the borehole and is seen to be effective.

In this section the effect of varying the trade-off weight βₐₜₜ on the resultant borehole trajectory is investigated for the closed loop trajectory controller. The simulation parameters are the same as in the previous section with the curvature constraint being fixed at 9°/100 ft. The values for the trade-off weight are chosen βₐₜₜε{0.2, 0.05, 0.01}.

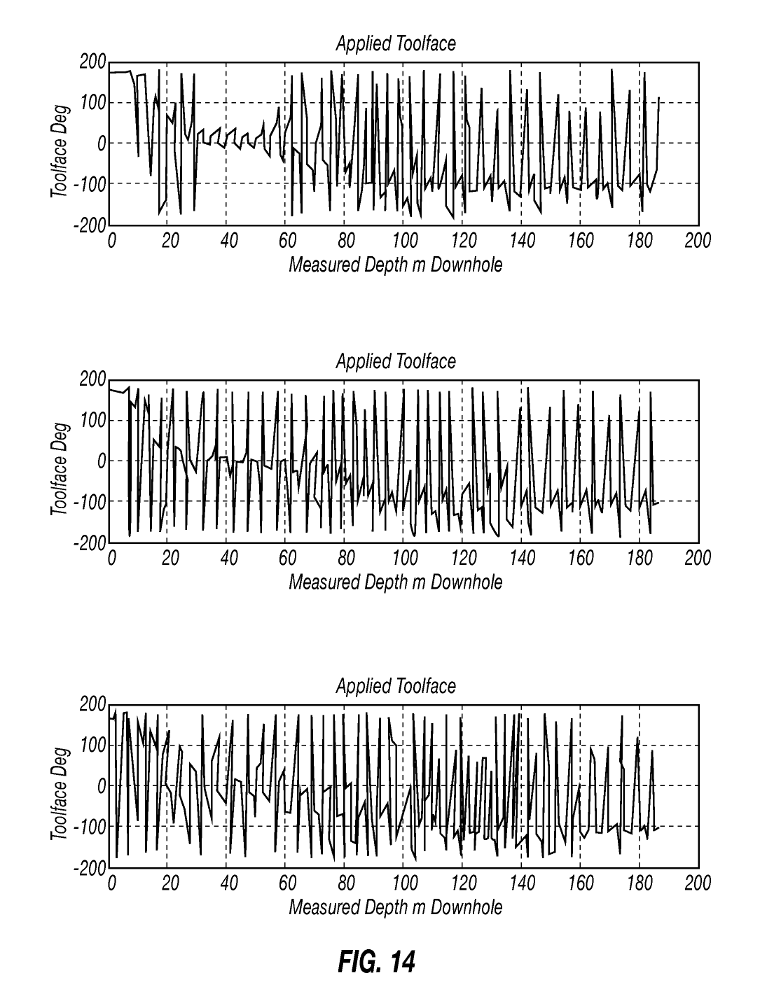

The deviation of the borehole trajectory from the well-plan is displayed in FIG. 14 verses measured depth. The effect of decreasing the weight βₐₜₜ has the effect of reducing how quickly the borehole trajectory reaches the well-plan where for the case of βₐₜₜ=0.2, the borehole trajectory was first coincident with the well-plan at about 50 m, whereas for the case of βₐₜₜ=0.01, this depth value was about 70 m. Furthermore the tracking of the well-plan is compromised when reducing the weight to βₐₜₜ=0.01 which after reaching, tracks the well-plan after 100 m with a larger deviation than the other two cases.

The toolface signals generated by the attitude control system are shown for the three cases in FIG. 14. The bursts where the toolface is held are reduced in frequency and duration when the weight βₐₜₜ is reduced. This implies that since there are more rotations of the toolface, then there curvature of the hole is reduced because the finite horizon optimization has emphasis on minimizing the energy of the correction path, in preference to the deviation from the well-plan.

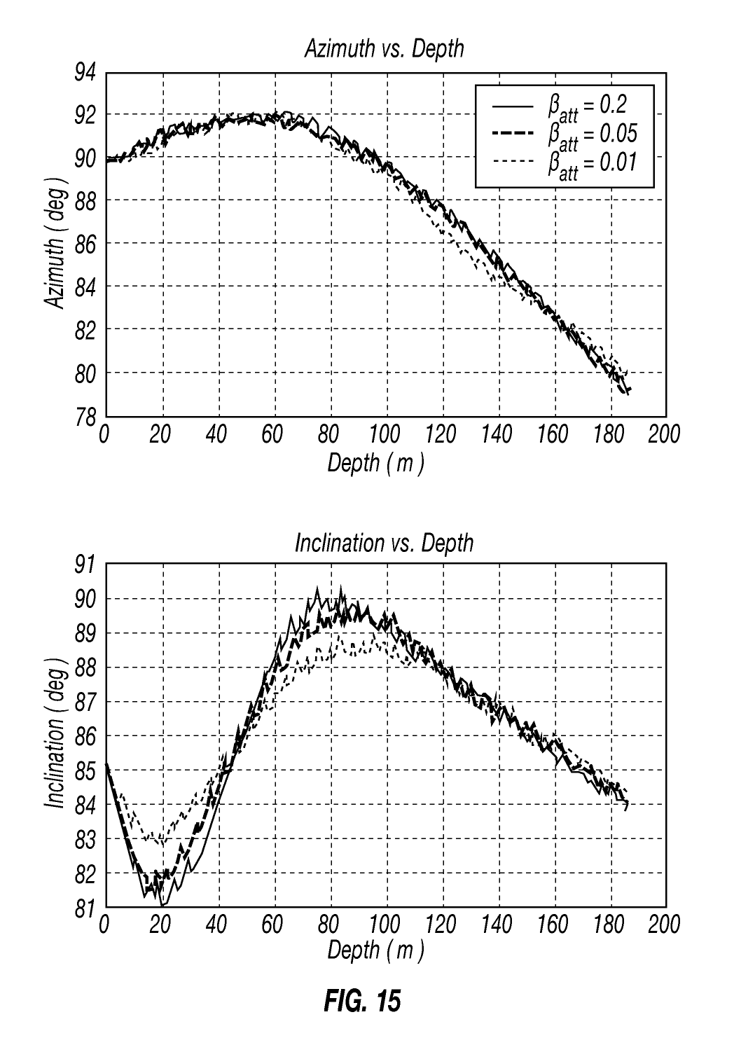

The attitudes in terms of inclination and azimuth angles are shown in FIG. 15. The difference in the attitudes can mainly be seen in the inclination where the higher the weight βₐₜₜ implies a greater variation in inclination.

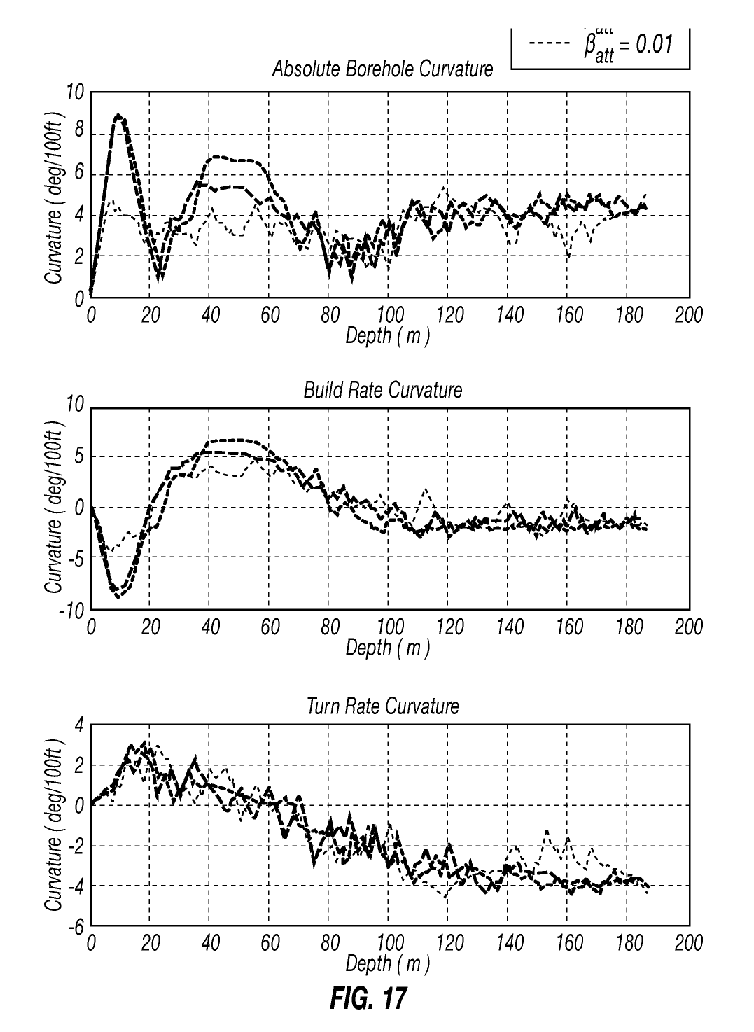

The instantaneous curvature on the predicted correction-path is shown in FIG. 16. The finite horizon optimization does not affect the maximum curvature as all three cases have a 9°/100 ft section at the start of the trajectory, as this is still allowed in the optimization. The effect of changing βₐₜₜ along the path is in a lower variation in curvature. This can be seen more clearly in FIG. 17.

Embodiments of the invention include systems and/or methods for controlling the propagating trajectory of a borehole produced by a rotary steerable system. The control system can be based on a model predictive control strategy where a convex quadratically constrained quadratic program is solved to generate optimal curves based on b-splines. These b-splines can be feasible trajectories where the control input can be recovered. In some embodiments, the control system can be based as an outer-loop to a stable attitude control system there the input for the latter will be an attitude demand signal. Some embodiments of the invention include methods and/or systems for optimizing curvature constrained 3D splines based on a multi-objective optimization of minimizing tortuosity and deviation from a well-plan.

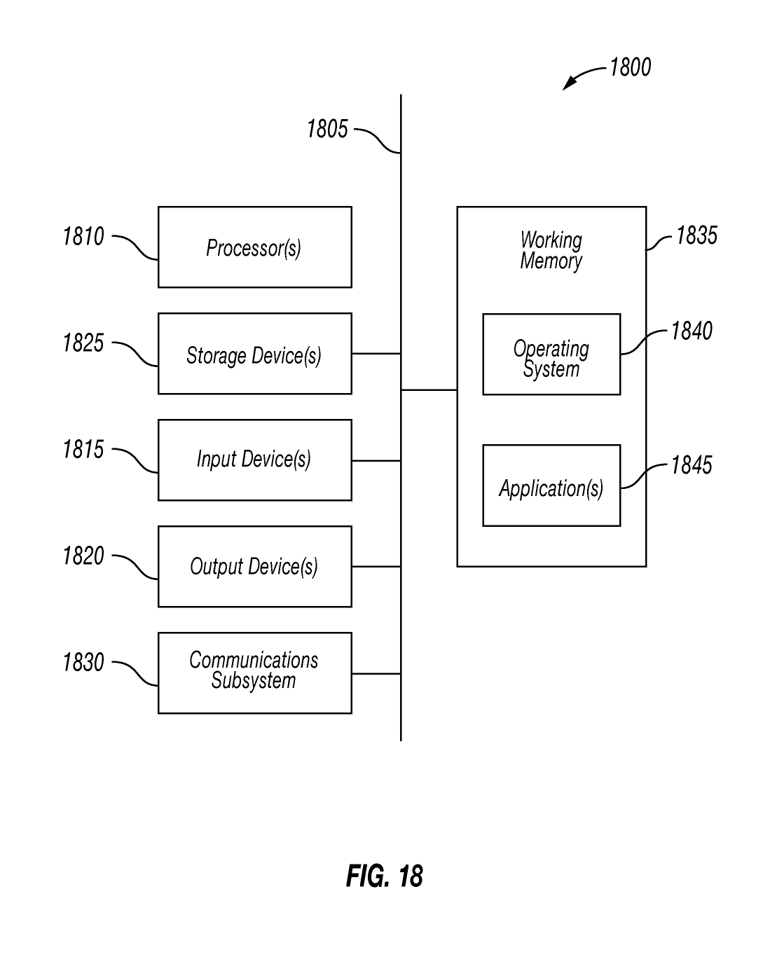

Some embodiments of the invention can be implemented using a computational system such as a server or computer system. An example of a computational system is shown in FIG. 18. In some embodiments multiple distributed computational systems can be geographically distributed. Moreover, various calculations, methods, and/or algorithms can be followed and/or solved using computation system 1800.

Computational system 1800 includes hardware elements that can be electrically coupled via a bus 1805 (or may otherwise be in communication, as appropriate). The hardware elements can include one or more processors 1810, including without limitation one or more general-purpose processors and/or one or more special-purpose processors (such as digital signal processing chips, graphics acceleration chips, and/or the like); one or more input devices 1815, which can include without limitation a mouse, a keyboard and/or the like; and one or more output devices 1820, which can include without limitation a display device, a printer and/or the like.

The computational system 1800 may further include (and/or be in communication with) one or more storage devices 1825, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 1800 might also include a communications subsystem 1830, which can include without limitation a modem, a network card (wireless or wired), an infrared communication device, a wireless communication device and/or chipset (such as a Bluetooth device, an 1802.6 device, a WiFi device, a WiMax device, cellular communication facilities, etc.), and/or the like. The communications subsystem 1830 may permit data to be exchanged with a network (such as the network described below, to name one example), and/or any other devices described herein. In many embodiments, the computational system 1800 will further include a working memory 1835, which can include a RAM or ROM device, as described above.

The computational system 1800 also can include software elements, shown as being currently located within the working memory 1835, including an operating system 1840 and/or other code, such as one or more application programs 1845, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1825 described above.

In some cases, the storage medium might be incorporated within the computational system 1800 or in communication with the computational system 1800. In other embodiments, the storage medium might be separate from a computational system 1800 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 1800 and/or might take the form of source and/or installable code, which, upon compilation and/or installation on the computational system 1800 (e.g., using any of a variety of generally available compilers, installation programs, compression/decompression utilities, etc.) then takes the form of executable code.

Embodiments of the invention can be used for any type of trajectory control system. For example, embodiments of the invention can be used in UAV's mobile robots, remote control cars, remote control aircraft, etc.

Embodiments of the invention include systems and/or methods for controlling the trajectory of a borehole produced by a rotary steerable system. The control system can be based on a model predictive control strategy where a convex quadratically constrained quadratic program is solved to generate optimal curves based on b-splines. These b-splines can be feasible trajectories where the control input can be recovered. In some embodiments, the control system can be based as an outer-loop to a stable attitude control system there the input for the latter will be an attitude demand signal. Some embodiments of the invention include methods and/or systems for optimizing curvature constrained 3D splines based on a multi-objective optimization of minimizing tortuosity and deviation from a well-plan.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. A method for determining an optimal borehole trajectory in real-time for drilling a borehole in a drilling procedure using a drilling system through an earth formation, comprising:
receiving a well-plan, wherein the well-plan is designed to describe a goal borehole extending from a surface location to a goal in the earth formation, wherein the goal is a volume of hydrocarbons in the earth formation;
receiving real-time drill bit and/or borehole data during the drilling procedure; and
determining a borehole trajectory based on the well plan, the drill bit and/or borehole data, wherein the borehole trajectory is determined using a plurality of objectives comprising at least a first objective of minimizing at least one of strain energy and torsion and a second objective of minimizing deviation of the borehole trajectory from the well-plan.

2. The method of claim 1, wherein the first and the second objectives are provided weightings.

3. The method of claim 2, wherein the weightings are adjusted during the drilling procedure.

4. The method of claim 1, wherein the strain energy and/or the torsion are determined for a pipe of a defined diameter deployed in the borehole.

5. The method of claim 4, wherein the pipe comprises a casing string to be used to case the borehole and the defined diameter comprises a diameter of the casing string.

6. The method of claim 1, further comprising:
using one or more constraints to constrain the determination of the borehole trajectory.

7. The method of claim 6, wherein the constraints comprise at least one of: directional drilling capabilities of the drilling system, properties of a rock formation being drilled or to be drilled, locations of existing wells in the earth formation, salt bodies in the earth formation and one or more additional hydrocarbon targets in the earth formation.

8. The method of claim 1, wherein determining the borehole trajectory comprises using prior drill bit and/or borehole data.

9. The method of claim 1, wherein determining the borehole trajectory comprises using prior drilling experience.

10. The method of claim 1, wherein determining the borehole trajectory comprises using model predictive control to predict compliance to the first or second objectives for a range of different proposed trajectories.

11. The method of claim 10, wherein determining the borehole trajectory comprises optimizing the compliance with at least one of the first and the second objectives.

12. The method of claim 10, wherein model predictive control is performed iteratively.

13. The method of claim 1, wherein the plurality of objectives comprises a third objective comprising wear on the drilling system.

14. The method of claim 1, wherein the plurality of objectives comprises a fourth objective comprising a time duration to drill the borehole to the goal.

15. The method of claim 1, wherein the plurality of objectives comprises a fifth objective comprising minimizing a curvature of the borehole between the surface location and the goal.

16. The method of claim 1, wherein the first objective of minimizing at least one of strain energy and torsion comprises minimizing a curvature of the borehole.

17. The method of claim 1, further comprising:
using recursive optimization to optimize the plurality of objectives.

18. The method of claim 17, wherein the plurality of objectives are iteratively optimized during the drilling procedure.

19. A system for drilling an optimal borehole trajectory, comprising:
a processor including instructions which when executed provide for determining the drilling trajectory in accordance with claim 1.

20. The system of claim 19, further comprising:
one or more sensors configured to sense at least one of one or more operating parameters of the drilling system, borehole parameters and/or properties of the earth formation being drilled.

21. The system of claim 20, wherein the sensors communicate data to a surface processor via wired drillpipe.
